(19) United States
(12) Patent Application Publication
(10) Pub. No.: US 2020/0122683 A1
(43) Pub. Date: Apr. 23, 2020

(54) ANTI-THEFT CONTROL METHOD FOR A VEHICLE

(71) Applicant: INDUSTRIAL TECHNOLOGY RESEARCH INSTITUTE, Hsinchu (TW)

(72) Inventor: Jia-Wei HUANG, Hsinchu (TW)

(21) Appl. No.: 16/232,577

(22) Filed: Dec. 26, 2018

(30) Foreign Application Priority Data
Oct. 17, 2018 (TW) 107136595

(51) Int. Cl. B60R 25/08; B60R 25/10; B60R 25/40; B60R 25/20

(52) U.S. Cl. CPC B60R 25/08; B60R 25/1001; B60R 25/403; B60L 7/00; B60R 2325/30; B60Y 2200/91; B60R 25/20

(57) ABSTRACT

An anti-theft control method for a vehicle comprises determining whether an enabling signal is received by a control device in an anti-theft mode; performing an anti-theft control process by the control device when receiving the enabling signal, wherein the anti-theft control process comprising: detecting a set of position information related to the motor by a position sensor; generating an anti-theft control command according to the set of position information and further outputting a plurality of switching control instructions according to the anti-theft control command by the control device; and outputting a locking command to the motor by a power driving device according to the plurality of switching control instructions for driving the motor to generate a braking force. The locking command comprises a plurality of PWM signals, with one of the plurality of PWM signals has two adjacent periods having the same duty ratio.

### CROSS-REFERENCE TO RELATED APPLICATIONS

This non-provisional application claims priority under 35 U.S.C. § 119(a) on Patent Application No(s). 107136595 filed in Taiwan, R.O.C. on Oct. 17, 2018, the entire contents of which are hereby incorporated by reference.

### BACKGROUND

### 1. Technical Field

This disclosure relates to an anti-theft control method for a vehicle, more particularly to an anti-theft control method for a vehicle using a motor braking-force.

### 2. Related Art

With the popularization of electric vehicles, people pay more attention to the issues of safety and anti-theft of electric vehicles. Nowadays, the general anti-theft of electric vehicles is mainly based on the use of external security equipment such as general mechanical anti-theft locks, magnetic anti-theft locks or electrical anti-theft locks for providing vehicle anti-theft functions.

The types of anti-theft locks mentioned above come with a certain difficulty in being unlocked for avoiding vehicles to be stolen. However, the risk which the vehicles are stolen still exists if the anti-theft locks are broken by someone. Therefore, it would be an important issue in the field to provide an efficient anti-theft function without equipping with additional anti-theft equipment.

### SUMMARY

According to one embodiment of this present disclosure, an anti-theft control method for a vehicle adapted to a motor of a vehicle is disclosed. The control method for a vehicle anti-theft comprising the following steps: determining whether an enabling signal is received by a control device in an anti-theft mode; performing an anti-theft control process by the control device when receiving the enabling signal, wherein the anti-theft control process comprising: detecting a set of position information related to the motor by a position sensor electrically connected to the motor; generating an anti-theft control command according to the set of position information and further outputting a plurality of switching control instructions according to the anti-theft control command by the control device; and outputting a locking command to the motor by a power driving device electrically connected to the control device according to the plurality of switching control instructions for driving the motor to generate a braking force; wherein the locking command comprises a plurality of PWM signals, with one of the plurality of PWM signals has two adjacent periods, a duty ratio of one of the two adjacent periods is identical to a duty ratio of the other one of the two adjacent periods.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of an anti-theft control system for a vehicle according to one embodiment of the present disclosure;

FIG. 2A is a flow chart of an anti-theft control method for a vehicle according to one embodiment of the present disclosure;

FIG. 2B is a flow chart of an anti-theft control process PC1 according to one embodiment of the present disclosure;

FIG. 3A to FIG. 3D are waveforms of the PWM signals according to different embodiments of the present disclosure;

FIG. 4 is a detailed schematic diagram of the anti-theft control system for a vehicle according to the embodiment of FIG. 1 in the present disclosure;

FIG. 5A is a detailed flow chart of an anti-theft control method for a vehicle according to the embodiment of FIG. 2A in the present disclosure;

FIG. 5B is a detailed flow chart of an anti-theft control process PC2 according to the embodiment of FIG. 2B in the present disclosure; and

FIG. 6 is a waveform diagram of the switching control instructions according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

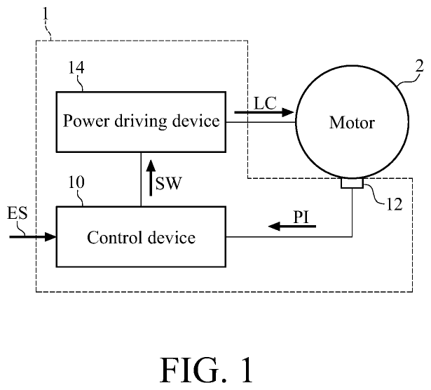

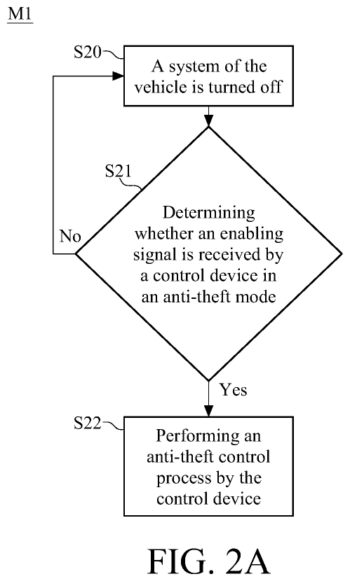

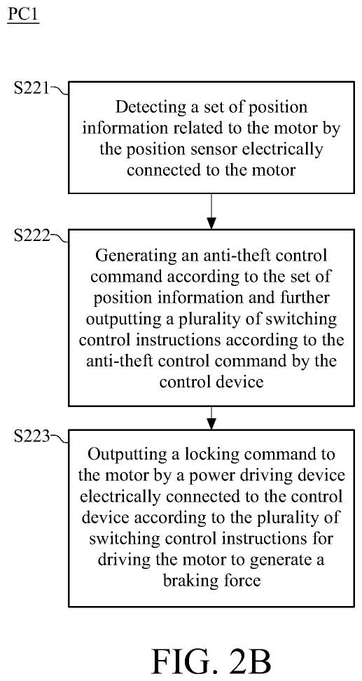

Please refer to FIG. 1 and FIG. 2A, FIG. 1 is a schematic diagram of an anti-theft control system for a vehicle according to one embodiment of the present disclosure, and FIG. 2A is a flow chart of an anti-theft control method M1 for a vehicle according to one embodiment of the present disclosure. The anti-theft control method M1 for a vehicle shown in FIG. 2A can be implemented by the anti-theft control system 1 for a vehicle shown in FIG. 1. As shown in FIG. 1, the anti-theft control system 1 includes a control device 10, a position sensor 12 and a power driving device 14. The control device 10 is electrically connected to the position sensor 12 and the power driving device 14. The position sensor 12 is configured to detect a vehicle motor 2 of a vehicle (hereafter referred to as a “motor 2”), and an output terminal of the power driving device 14 is electrically connected to the motor 2.

In the anti-theft control method M1 for a vehicle of the present disclosure, as shown in FIG. 2A, in the step S20, a system of the vehicle is turned off. In the step S21, determining whether an enabling signal ES is received by the control device 10 in an anti-theft mode. The enabling signal ES is either referred to as an alarm trigger signal or a wheel-rotation signal. When the control device 10 receives the enabling signal ES, performing an anti-theft control process PC1 by the control device 10 according to the enabling signal ES in the step S22. Specifically, the anti-theft control method M1 for a vehicle of the present disclosure is mainly adapted to a condition in which the vehicle is switched off. In more detail, after the vehicle is switched off, the control device 10 determines whether to perform the anti-theft control process PC1 to prevent the vehicle from being stolen based on the present or absent of the enabling signal ES in the anti-theft mode.

Please further refer to FIG. 2B, which is a flow chart of the anti-theft control process PC1 according to one embodiment of the present disclosure. As shown in FIG. 2B, the anti-theft control process PC1 performed by the control device 10 includes the steps S221-S223. In the step S221, a set of position information PI related to the motor 2 is detected by the position sensor 12 electrically connected to the motor 2. Specifically, the set of position information PI is a set of rotation information of the motor 2. In more detail, the position sensor 12 is capable of detecting a rotation state of a rotor relative to a stator within the motor 2 for obtaining the set of rotation information of the motor 2. In the step S222, an anti-theft control command SI is generated according to the set of position information PI and further a plurality of switching control instructions included in a set of driving command SW are output according to the anti-theft control command SI by the control device 10. In the step S223, a locking command LC is output to the motor 2 according to the plurality of switching control instructions by the power driving device 14, which electrically connects to the control device 10, for driving the motor 2 to generate a brake force (e.g. brake torques in the motor 2).

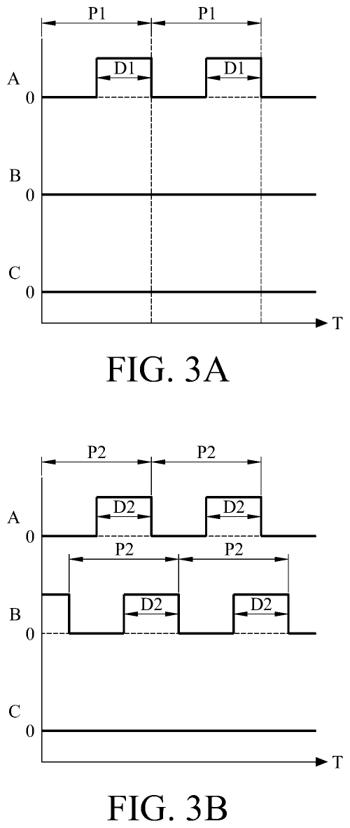

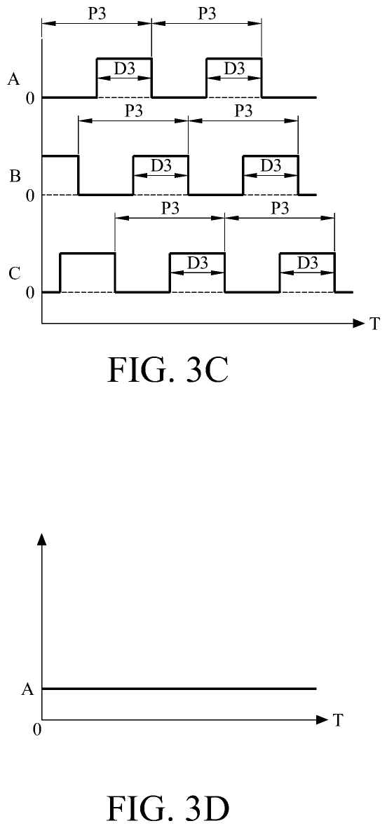

The locking command LC includes a plurality of Pulse Width Modulation (PWM) signals such as signals A-C shown in FIGS. 3A, 3B, 3C, and 3D. One of the plurality of PWM signals at least has two adjacent periods with the same duty ratio. For example, in FIG. 3A, the signal C has a period P1, wherein each of the period P1 has a duty ratio D1/P1. Any two adjacent periods have same duty ratio D1/P1. In more detail, the plurality of PWM signals are supplied to the motor 2, so that the motor 2 is capable of generating the brake force to lock the motor 2 itself. Accordingly, the speed of the vehicle remains zero to prevent the vehicle from being moved by external forces. In an alternative implementation, the motor 2 is a three-phase motor, and the plurality of PWM signals have three signals (e.g. signals A-C of the PWM signals in FIGS. 3A, 3B, 3C, and 3D) respectively outputted to coils of the three phases of the motor 2.

In the anti-theft control method M1 for a vehicle disclosed in the present disclosure, the control device 10 outputs the switching control instructions according to the set of position information PI detected by the position sensor 12, so as to drive the power driving device 14 to output the PWM signals with periods having specific duty ratios to the motor 2. As a result, the motor 2 is capable of generating the brake force to compete with the external forces according to the PWM signals. Since the brake force is used for locking the motor 2, the speed of the vehicle remains zero, so that a thief is not able to move the vehicle easily. Thereby, the purpose of vehicle anti-theft could be achieved efficiently. Detailed illustrations regarding the period types of the aforementioned PWM signals will be given in the following paragraphs.

Please refer to FIG. 3A-FIG. 3D, which are waveforms of the PWM signals according to different embodiments of the present disclosure. The PWM signals A-C (hereafter “signals A-C”) shown in FIG. 3A-FIG. 3D are signals respectively outputted to the three-phase coils of the motor 2 from the power driving device 14. More specifically, the motor 2 is a three-phase motor, which has three sets of coils (U, V, W phases) connected to the power driving device 14 for receiving the signals A-C respectively in order to generate rotational magnetic fields. The rotational magnetic fields in the motor 2 make the stator attract the rotor, resulting in a magnetic torque (hereafter referred to as a braking torque or a braking force). In the embodiment of FIG. 3A, the signal A has a period P1, with each of them having the same pulse duration D1. In other words, any two adjacent periods P1 of the signal A have the same duty ratio D1/P1 while voltages of the signal B and the signal C remain zero.

Compared to the embodiment of FIG. 3A, in the embodiment of FIG. 3B, both of the signal A and the signal B have periods P2 each having a pulse duration D2. Any two adjacent periods of the signal A and the signal B have the same duty ratio D2/P2, and a phase angle of the signal A is different from a phase angle of the signal B while the voltage of the signal C remains zero. In one embodiment, a phase angle difference between the phase angle of the signal A and the phase angle of the signal B is 120 degrees, resulting in a better brake force. However, the present disclosure is not limited to the above embodiment. In practice, the phase angle difference between the phase angle of the signal A and the phase angle of the signal B may be 90 degrees, 135 degrees or 150 degrees. The phase angle difference of 90 degrees represents a quarter (¼) of the period P2, the phase angle difference of 135 degrees represents a three eighth (⅜) of the period P2, and the phase angle difference of 150 degrees represents a five twelfth ( 5/12) of the period P2.

On the other hand, compared to the embodiments of FIG. 3A and FIG. 3B, in the embodiment of FIG. 3C, the signals A-C all have periods P3 each having a pulse duration D3. Any two adjacent periods of each of the signals A-C have the same duty ratio D3/P3, and the phase angles of the signal A, the signal B and the signal C are different from one another. In one embodiment, the phase angle differences among the signal A, the signal B and the signal C are all 120 degrees, which represents a one third (⅓) of the period P3, but the present disclosure is not limited to the embodiment. In other embodiments, the phase angle differences among the signal A, the signal B and the signal C are all 90 degrees (namely a one fourth (¼) of the period of P3), 135 degrees (namely a three eighth (⅜) of the period P3) or 150 degrees (namely a five twelfth ( 5/12) of the period P3). By taking the characteristics of the same duty ratio of the periods in the PWM signals as well as the phase angle differences between the PWM signals, the three-phase motor 2 generates the brake force. In practice, the signals A-C are represented in forms of high/low level, and a pulsed height of each of them may be different depending on the voltage requirement of the motors. For example, a motor of a general electric vehicle may require voltages of 6 volts, 12 volts or even 48 volts.

In another embodiment, any two adjacent periods of the PWM signal (e.g. the signal A) both have a duty ratio of 100%. The duty ratio of 100% of the two adjacent periods of the PWM signal represents that the PWM signal has a fixed voltage (namely a DC voltage), as shown in FIG. 3D. In the embodiment, compared to the signal A in a form of DC voltage, each of the rest of signals B-C could have a voltage of zero or could be a pulsed signal with a certain duty ratio, or any of the rest of signals B-C could be in a form of DC voltage, as shown in the embodiments of FIG. 3A-3C.

In this embodiment, the anti-theft control method M1 for a vehicle disclosed in the present disclosure sets one of the PWM signals (any of signals A-C) to be a DC voltage inputting into a coil of one phase of the motor 2 for driving the motor 2 to generate the brake force. FIG. 3D shows a positive fixed voltage. However, in other embodiment, it is possible to set one of the PWM signals to be negative fixed voltage inputting into a coil of one phase of the motor 2 for driving the motor 2 to generate the brake force.

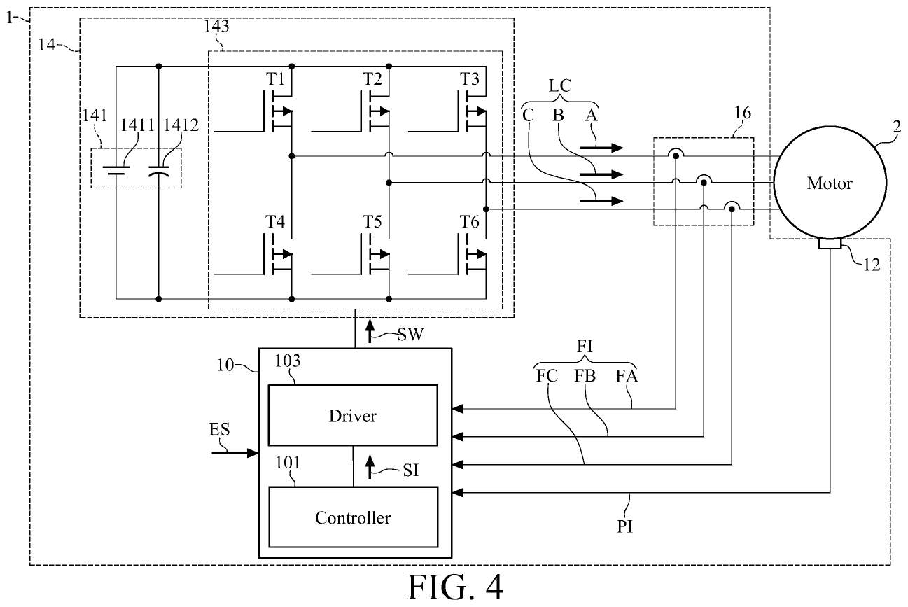

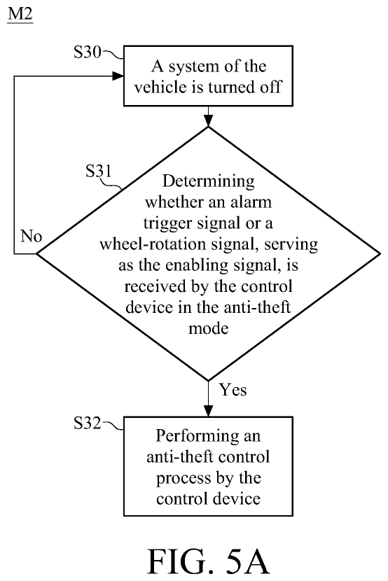

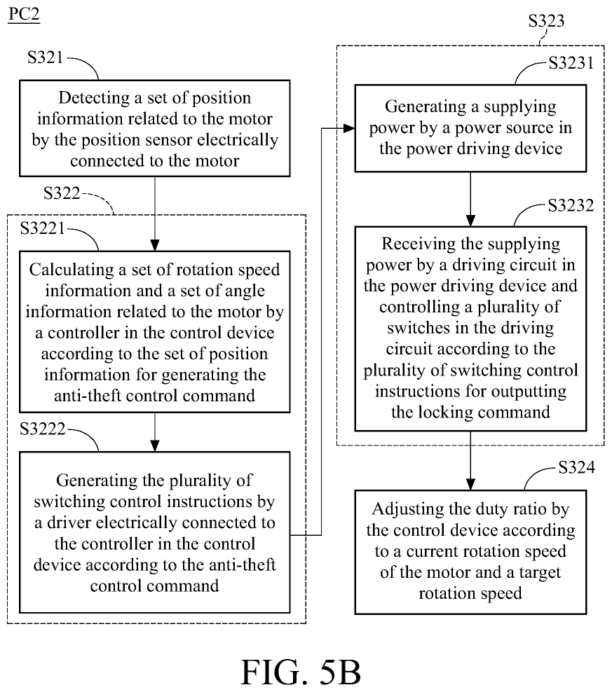

Please refer to FIG. 4, FIG. 5A and FIG. 5B, FIG. 4 is a detailed schematic diagram of the vehicle anti-theft control system 1 according to the embodiment of FIG. 1 in the present disclosure. FIG. 5A is a detailed flow chart of the anti-theft control method M2 for a vehicle according to the embodiment of FIG. 2A in the present disclosure, and FIG. 5B is a detailed flow chart of an anti-theft control process PC2 according to the embodiment of FIG. 2B in the present disclosure. FIG. 4 shows a detailed structure of the vehicle anti-theft control system 1 shown in the embodiment of FIG. 1. As shown in FIG. 4, the control device 10 includes a controller 101 and a driver 103. The power driving device 14 includes a power source 141 and a driving circuit 143. The driving circuit 143 has a plurality of switches T1-T6. Three output terminals of the driving circuit 143 are electrically connected to the coils of the three phases of the motor 2 respectively, and the power source 141 includes an electric power source 1411 and a capacitor 1412.

The anti-theft control method M2 for a vehicle shown in FIG. 5A can be implemented by the vehicle anti-theft control system 1 shown in FIG. 4. The steps of the anti-theft control method M2 for a vehicle shown in FIG. 5A are basically similar to the steps of the anti-theft control method M1 for a vehicle shown in FIG. 2A, namely, the step S30 corresponds to the step S20, the step S31 corresponds to the step S21, and the step S32 corresponds to the step S22, wherein the step S32 includes performing an anti-theft control process PC2. The steps of the anti-theft control process PC2 shown in FIG. 5B are basically similar to the steps of the anti-theft control process PC1 shown in FIG. 2B, namely the step S321 corresponds to the step S221, the step 322 corresponds to the step S222, and the step S323 corresponds to the step S223. The difference lies in that the step S31, the step S322 and the step S323 further include detailed steps. The step S222 corresponds to the step S322, wherein the step S322 includes the step S3221 and the step S3222; the step S223 corresponds to the step S323, wherein the step S323 includes the step S3231 and the step S3232. Specifically, in one embodiment, determining whether the enabling signal ES is received by the control device 10 in the anti-theft mode is shown in the step S21. The step S21 includes determining whether an alarm trigger signal or a wheel-rotation signal is received by the control device 10 in the anti-theft mode. The alarm trigger signal and the wheel-rotation signal both serves as the enabling signal ES, as shown in the step S31.

Specifically, the enabling signal ES is either referred to as the alarm trigger signal or the wheel-rotation signal. In practice, a vehicle is generally equipped with an alarm device (not shown in figure) for detecting abnormal situations such as vehicle vibrations, external voices or car doors opened. When the vehicle is in the anti-theft mode and the alarm device senses any of the above abnormal situations, it means that someone would like to steal the vehicle. Accordingly, the alarm device sends out an alarm trigger signal to the control device 10 as the enabling signal ES for performing the anti-theft control process PC2. In one embodiment, a vehicle generally equipped with an inertial measurement unit (IMU). The IMU is a device configured to measure three-axis orientations (or angular speeds) and accelerations of a vehicle, and the signal outputted by the IMU serves as the enabling signal ES.

On the other hands, in one embodiment, the vehicle is equipped with a sensor (not shown in figure) configured to sense rotations of one or more wheels. When the vehicle is in the anti-theft mode and the sensor senses the rotations of one or more wheels connected to the motor 2, it indicates that someone would like to steal the vehicle. Accordingly, the sensor sends out a wheel-rotation signal to the control device 10 as the enabling signal ES for performing the anti-theft control process PC2. In a real implementation, when the control device 10 no longer receives the alarm trigger signal or the wheel-rotation signal, it means that the risk of vehicle theft is removed and the flow of the anti-theft control method for the vehicle is ended.

In one embodiment, the step S222 of FIG. 2B showing that the anti-theft control command SI is generated according to the set of position information PI and further the plurality of switching control instructions are output according to the anti-theft control command SI by the control device 10 is equivalent to the step S322. The step S322 includes the step S3221 and the step S3222 in FIG. 5B. In the step S3221, a set of rotation speed information and a set of angle information related to the motor 2 are calculated by a controller 101 in the control device 10 according to the set of position information PI for generating the anti-theft control command SI. In the step S3222, the set of driving command SW including the plurality of switching control instructions SW1-SW6 is generated by the driver 103. The driver 103 is electrically connected to the controller 101 in the control device 10 according to the anti-theft control command SI.

Specifically, the position sensor 12 sends the position information PI, which is generated by the motor 2, feeding back to the controller 101 per unit time. As a result, the controller 101 obtains a set of rotation speed information and a set of angle information through calculations performed based on the feedback position information PI. When a thief moves the vehicle, the controller 101 properly generates an anti-theft control command SI according to the calculation based on the position information PI of the motor 2 sent by the position sensor 12. Then, the controller 101 further sends the anti-theft control command SI to the driver 103, so that the driver 103 uses a PWM technique to generate a driving command SW. The driving command SW includes a plurality of switching control instructions SW1-SW6 for controlling the power driving device 14 to output the PWM signals, as shown in FIG. 3A-3D. The PWM signals send to the motor 2 for generating the brake force.

In one embodiment, the step S223 of FIG. 2B shows that the locking command LC (e.g. signals A-C of the PWM signals in FIGS. 3A, 3B, 3C, and 3D) is output to the motor 2 according to the plurality of switching control instructions by the power driving device 14. The power driving device 14 is electrically connected to the control device 10 for driving the motor 2 to generate the brake force. The step S223 of FIG. 2B is equivalent to the step S323 of FIG. 5B. The step S323 includes the step S3231 and the step S3232 in FIG. 5B. In the step S3231, a supplying power is generated by a power source 141 in the power driving device 14. In the step S3232, the supplying power is received by a driving circuit 143 in the power driving device 14 and a plurality of switches T1-T6 in the driving circuit 143 is controlled according to the switching control instructions SW1-SW6 for outputting the locking command LC (e.g. signals A-C of the PWM signals in FIG. 4).

Specifically, the driving circuit 143 is a circuit including six semiconductor switches T1-T6. Each of the semiconductor switches T1-T6 receives a respective one of the switching control instructions SW1-SW6 so as to switch the supplying power. The supplying power is generated by the power source 141 for properly outputting three PWM signals (e.g. the signals A-C, the locking command LC) to the coils of the three-phase motor 2. Accordingly, the three-phase motor 2 generates a braking torque competing with external forces, so that the vehicle speed remains zero. Thereby, it efficiently prevents the vehicle from being stolen.

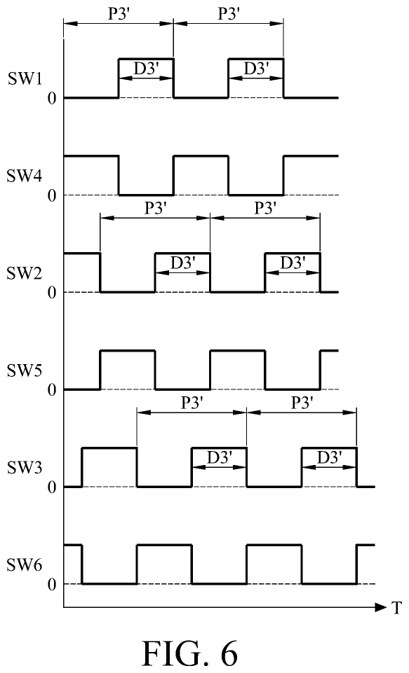

Practical examples for illustrating the switching control instructions SW1-SW6 are given below. Please further refer to FIG. 6, which is a waveform diagram of the switching control instructions SW1-SW6 according to one embodiment of the present disclosure. The PWM signals of FIG. 3C could be generated according to the switching control instructions SW1-SW6 of FIG. 6. Specifically, in FIG. 6, the switching control instructions SW1-SW3 are respectively supplied to the semiconductor switches T1-T3 of the upper arm while the switching control instructions SW4-SW6 are respectively supplied to the semiconductor switches T4-T6 of the lower arm. The semiconductor switches T1 and T4, the semiconductors switches T2 and T5, and the semiconductor switches T3 and T6 respectively correspond to the three phase arms of the motor 2.

As shown in FIG. 6, the switching control instructions SW1-SW3 has periods P3′ and pulse durations D3′. The switching control instructions SW1-SW3 have phase angle differences (e.g. 120 degrees between SW1 and SW2; 120 degrees between SW2 and SW3). The switching control instructions SW4-SW6 are inverted signals relative to the switching control instructions SW1-SW3. In more detail, in order to generate the signals A-C as shown in FIG. 3C, the waveforms of the switching control instructions SW1-SW3 supplied to the semiconductor switches T1-T3 of the upper arm have the same phases as the waveforms of the signals A-C respectively. While the waveforms of the switching control instructions SW4-SW6 supplied to the semiconductor switches T4-T6 of the lower arm have the inverted phases relative to the waveforms of the signals A-C respectively.

In one embodiment, as shown in FIG. 5B, in the anti-theft control method M2 for a vehicle disclosed in the present disclosure, the anti-theft control process PC2 further includes a step S324: the control device 10 adjusts the duty ratio according to a current rotation speed and a target rotation speed of the motor 2. In this embodiment, the target rotation speed is predetermined to be zero. In other words, the control device 10 would determine whether the current rotation speed of the motor 2 reaches the target rotation speed so as to properly adjust the duty ratio.

In a real implementation, the control device 10 determines an accurate anti-theft control command SI according to the set of position information PI fed back by the position sensor 12. The anti-theft control command SI drives the motor 2 to generate a corresponding brake force. However, the current rotation speed of the motor 2 could not return to zero when the generated brake force cannot compete with an external force generated due to the theft. In order to avoid this problem, in the method of the present disclosure, the control device 10 determines whether the current rotation speed reaches the target rotation speed (namely a rotation speed of zero) according to the set of position information PI detected by the position sensor 12. And the control device 10 properly adjusts the duty ratio of the PWM signal (e.g. adjust the duty ratio from 50% to 70%) for enhancing the brake force to increase the vehicle locking-force. Accordingly, the brake force is strong enough to compete with the external force, and the capability of the vehicle anti-theft is further raised.

In one embodiment, referring to FIG. 4, the anti-theft control process PC2 of the anti-theft control method M2 for a vehicle disclosed in the present disclosure further comprises generating a set of feedback current information FI according to the locking command LC (e.g. signals A-C of the PWM signals in FIG. 4) by a feedback circuit 16, wherein the set of feedback current information FI includes three feedback signals FA, FB and FC. Then, the power driving device 14 is controlled to adjust the outputted locking command LC according to the set of feedback current information FI and the set of position information PI by the control device 10. In detail, the control device 10 receives the set of position information PI given by the position sensor 12, and further the control device 10 converts the set of position information PI to a set of speed information. Furthermore, the control device 10 obtains the set of feedback current information FI from the feedback circuit 16. By taking both of the set of speed information and the set of feedback current information FI into consideration, the control device 10 properly adjusts the outputted locking command LC to regulate the brake force.

Based on the above description, the anti-theft control method for a vehicle is actuated mainly by detecting the present or absent of the enabling signal so as to determine whether to perform the anti-theft control method. In the anti-theft control method, the anti-theft control command is generated according to the set of position information PI of the vehicle motor. Corresponding to the set of position information PI, the switching control instruction is further released for driving the motor to generate the brake torque. Accordingly, the motor is locked and the thief cannot move the vehicle easily. Thereby, the purpose of vehicle anti-theft could be achieved efficiently without equipping with additional anti-theft devices.

What is claimed is:

1. An anti-theft control method for a vehicle, adapted to a motor of a vehicle, comprising:
determining whether an enabling signal is received by a control device in an anti-theft mode; and
performing an anti-theft control process by the control device when receiving the enabling signal, wherein the anti-theft control process comprises:
detecting a set of position information related to the motor by a position sensor electrically connected to the motor;
generating an anti-theft control command according to the set of position information and further outputting a plurality of switching control instructions according to the anti-theft control command by the control device; and
outputting a locking command to the motor by a power driving device electrically connected to the control device according to the plurality of switching control instructions for driving the motor to generate a braking force;
wherein the locking command comprises a plurality of PWM signals, with one of the plurality of PWM signals has two adjacent periods, a duty ratio of one of the two adjacent periods is identical to a duty ratio of the other one of the two adjacent periods.

2. The anti-theft control method according to claim 1, wherein determining whether the enabling signal is received by the control device in the anti-theft mode comprises:
determining whether an alarm trigger signal or a wheel-rotation signal is received by the control device in the anti-theft mode, with the alarm trigger signal and the wheel-rotation signal both serving as the enabling signal.

3. The anti-theft control method according to claim 2, wherein the wheel-rotation signal is generated by rotations of at least one wheel connected to the motor.

4. The anti-theft control method according to claim 1, wherein outputting the locking command to the motor by the power driving device electrically connected to the control device according to the plurality of switching control instructions comprises:
generating a supplying power by a power source in the power driving device; and
receiving the supplying power by a driving circuit in the power driving device and controlling a plurality of switches in the driving circuit according to the plurality of switching control instructions for outputting the locking command.

5. The anti-theft control method according to claim 1, wherein generating the anti-theft control command according to the set of position information and further outputting the plurality of switching control instructions according to the anti-theft control command by the control device comprises:
calculating a set of rotation speed information and a set of angle information related to the motor by a controller in the control device according to the set of position information for generating the anti-theft control command; and
generating the plurality of switching control instructions by a driver electrically connected to the controller in the control device according to the anti-theft control command.

6. The anti-theft control method according to claim 1, wherein another one of the plurality of PWM signals has two adjacent periods having the same duty ratio, and phase angles of the two PWM signals are different.

7. The anti-theft control method according to claim 1, wherein two adjacent periods of each of the plurality of PWM signals have the same duty ratio, and each of the plurality of PWM signals has a phase angle, with the plurality of phase angles different from one another.

8. The anti-theft control method according to claim 1, wherein the duty ratios of the two adjacent periods of the PWM signal are both 100%.

9. The anti-theft control method according to claim 1, wherein the anti-theft control process further comprises: adjusting the duty ratio by the control device according to a current rotation speed of the motor and a target rotation speed.

10. The anti-theft control method according to claim 1, wherein the anti-theft control process further comprises:
generating a set of feedback current information by a feedback circuit according to the locking command; and
controlling the power driving device by the control device, according to the set of feedback current information and the set of position information, to adjust the locking command.
